(19) United States
(12) Patent Application Publication
(10) Pub. No.: US 2018/0360081 A1
(43) Pub. Date: Dec. 20, 2018

(54) PROCESS FOR STABILIZING SUGAR BEETS

(71) Applicant: Timothy Brown, Presque Isle, ME (US)

(72) Inventor: Timothy Brown, Presque Isle, ME (US)

(21) Appl. No.: 15/625,238

(22) Filed: Jun. 16, 2017

(51) Int. Cl. A23L 19/00; A23K 50/10; A23K 20/10; A23N 12/08

(52) U.S. Cl. CPC A23L 19/03; A23K 50/10; A23V 2002/00; A23N 12/08; A23K 20/10

(57) ABSTRACT

The invention provides a process for stabilizing a sugar beet product against frost damage. The invention further provides a sugar beet product that is stabilized against frost damage.

### BACKGROUND OF THE INVENTION

The invention relates to processing sugar beets in a manner that allows them to be stored at ambient temperature in cold climates, where freeze thaw cycles in winter would otherwise render them useless. In addition, processing sugar beets in this manner protects them from hot and humid conditions in summer. Among other uses, sugar beets are useful as a part of feedstock for ruminant animals, including, without limitation, dairy cows.

The rumen of these animals can convert large volumes of low cost plant material into high value meat or milk by fermentation. The rate of this fermentation occurs optimally when microbes in the rumen receive a controlled supply of nutrients. If too much energy is provided too quickly, over-production of lactic acid in the rumen will cause acidosis, which is a condition of excessively low pH. The digestive upset resulting from this is generally harmful to the animal and reduces the efficiency of conversion of feedstock into milk and meat.

Sugar beets contain sufficient levels of digestible fiber to slow down the fermentation process in the lumen, when mixed with cereal feedstock, thereby preventing acidosis and optimizing the production of milk and meat. In addition, adding sugar beets to ruminant feedstock has the benefit of increasing the levels of butterfat in milk produced thereby.

A limiting problem to the utility of sugar beets in ruminant feedstock resides in storing them during winter conditions. Exposure to frost, and particularly to freeze-thaw conditions, causes the sugar beets to break down and develop mushy areas, which become susceptible to molds. The use of any such damaged sugar beets in feedstock upsets rumen function and causes diarrhea.

There is, therefore, a need for a process for stabilizing sugar beets against such frost damage.

### DESCRIPTION OF THE INVENTION

The present inventors have discovered a process for stabilizing sugar beets against frost damage. Surprisingly, reducing the water content of sugar beets within certain parameters stabilizes them and allows for their long-term storage at ambient temperatures, even under severely cold winter conditions, including freeze-thaw condition. Under these parameters, the processed sugar beet product remains both nutritious and palatable to ruminants. For purposes of the invention, a ruminant is a mammal that digests plant material through rumination. Such ruminants include, without limitation cattle, sheep and goats. One preferred ruminant is a dairy cow.

In the process according to the invention, sugar beet chips that are dimensioned to be suitable for drying are fed into a dryer at an initial drying temperature that becomes lower as the chips move through the length of the dryer from which they emerge at an emergent temperature. The dryer is generally metallic, and contains apertures that allow the beet chips to be in fluid communication with ambient air. The dryer rotates to enhance the fluid communication. In some embodiments, the initial drying temperature is from about 500° F. to about 700° F. In some embodiments, the initial drying temperature is about 600° F. The emergent temperature is not critical, but in some embodiments is below the boiling point of water, e.g. about 200° F.

Sugar beets, in good condition, generally have an initial water content of about 80%-85%. In the process according to the invention, the sugar beet chips are dried to a water content of from about 16% to about 26%. In some embodiments, the sugar beet chips are dried to a water content of about 20%. It is believed to be this water content that renders the sugar beet chips resistant to frost damage, while retaining their nutritional value and palatability for ruminant animals. The parameters of initial drying temperature and emergent drying temperature, as well as sugar beet chip dimension and drying time can be varied to achieve the proper water content.

The following examples are intended to further illustrate certain aspects of the invention and are not to be construed to limit the scope of the invention.

### EXAMPLE 1

### Small-Scale Process for Stabilizing Sugar Beet Chips

Sugar beets were cleaned and cut into chips of approximately 1″×1.5″×0.25″ and 85% water content. The chips were fed into a rotating cylindrical dryer of two feet diameter and 10 feet length. The dryer contained perforations to allow the chips to be in fluid communication with ambient air (about room temperature in this case). The dryer was positioned to allow the chips to proceed from the feeding end of the dryer to the emergent end of the dryer gravitationally in about 45 minutes. The initial drying temperature at the feeding end of the dryer was about 600° F. The chips emerged from the emergent end of the dryer at a temperature of about 200° F. The emerging chips were analyzed for water content, which was about 22%. The chips were then further analyzed for a number of nutritional and microbiological parameters, which are shown in Table I. Next, the chips were stored under ambient office temperature and humidity for three months and visually inspected periodically. All inspections of the product revealed no visual color change or mold growth.

[symbol]

### EXAMPLE 2

### Large-Scale Process for Stabilizing Sugar Beet Chips

Sugar beets are cleaned and cut into chips of approximately ¼″ (normally distributed profile) and 80% water content. The chips are fed into a rotating cylindrical dryer (rotation rate of about 30 rpm) of 14 feet diameter and 60 feet length. The dryer has a galvanized corrugated skin to allow the chips to be in fluid communication with ambient air (about room temperature in this case). The dryer is designed to allow the chips to proceed from the feeding end of the dryer to the emergent end of the dryer at a rate of about 40,000 lbs/hour. The initial drying temperature at the feeding end of the dryer is about 750° F. The chips emerge from the emergent end of the dryer at a temperature of about 250° F. The emerging chips are analyzed for water content, which is about 20%.

1. A process for stabilizing sugar beet product, comprising: feeding sugar beet chips that are dimensioned to be suitable for drying into a rotating dryer having a feeding end, a length and an emergent end, wherein the dryer has apertures that allow the sugar beet chips to be in fluid communication with ambient air, wherein the feeding end of the dryer is at an initial drying temperature and the emergent end is at a lower emergent temperature, and allowing the chips to pass through the dryer at a rate such that the chips emerge from the emergent end of the dryer having a water content of from about 16% to about 26%.

2. The process according to claim 1, wherein the chips emerge from the emergent end of the dryer having a water content of about 20%.

3. The process according to claim 1, wherein the initial drying temperature is from about 500° F. to about 800° F.

4. The process according to claim 3, wherein the initial drying temperature is about 750° F.

5. The process according to claim 1, wherein the emergent temperature is below the boiling point of water.

6. The process according to claim 5, wherein the emergent temperature is about 200° F.

7. The process according to claim 1, wherein the rotating dryer rotates from about 20 rpm to about 40 rpm.

8. The process according to claim 1, wherein the chips pass through the rotating dryer as a result of gravity.

9. The process according to claim 1, wherein the chips are of approximately ¼″, normally distributed profile.

10. A stabilized sugar beet product made according to the process of claim 1.

11. A stabilized sugar beet product having a water content of from about 16% to about 26%.

12. A stabilized sugar beet product having a water content of about 20%.

13. The use of the stabilized sugar beet product according to claim 10, in a feedstock for ruminant animals.

14. The use according to claim 12, wherein the ruminant animal is a bovine animal.

15. The use according to claim 13, wherein the bovine animal is a dairy cow.
